(19) United States
(12) Patent Application Publication
(10) Pub. No.: US 2026/0156518 A1
(43) Pub. Date: Jun. 4, 2026

(54) ENHANCED RESIDENTIAL GATEWAY FOR 5G

(71) Applicant: INTERDIGITAL PATENT HOLDINGS, INC., Wilmington, DE (US)

(72) Inventors: Debashish Purkayastha, Collegeville, PA (US); Shahrukh Khan Kasi, Quetta (PK); Xiaoyan Shi, Lake Oswego, OR (US); Robert Gazda, Spring City, PA (US); Tezcan Cogalan, London (GB); Taimoor Abbas, Sainte-Julie (CA)

(73) Assignee: INTERDIGITAL PATENT HOLDINGS, INC., Wilmington, DE (US)

(21) Appl. No.: 18/707,457

(22) PCT Filed: Nov. 4, 2022
(86) PCT No.: PCT/US2022/049012

§ 371 Date: May 3, 2024

Related U.S. Application Data
(60) Provisional application No. 63/276,329, filed on Nov. 5, 2021.

(51) Int. Cl. H04W 28/02; H04W 28/088; H04W 88/16

(52) U.S. Cl. CPC H04W 28/0268; H04W 28/088; H04W 88/16

(57) ABSTRACT

In one or more systems, methods, and/or devices, an enhanced residential gateway (eRG) may perform registration for 5GS and CPN identification. This may include a registration procedure for the eRG, and/or a service request procedure for the eRG. Additionally, in the eRG, the user plane of a wireless transmit receive unit (WTRU) may be handled. This may include a procedure for the eRG for WTRU registration, and/or PDU session establishment for local breakout in the CPN.

### CROSS-REFERENCE TO RELATED APPLICATIONS

This application claims the benefit of U.S. Provisional Application No. 63/276,329, filed Nov. 5, 2021, the contents of which are incorporated herein by reference.

### BACKGROUND

In wireless systems, the mobility of handsets will always present issues with how services are handled as a handset moves. With an increasing number of use cases that demand higher QoS, even while services are transitioned as a handset moves, there is a need to ensure that some functions are streamlined by possibly moving certain functions related to the mobility of a handset to a specific location.

### SUMMARY

In one or more systems, methods, and/or devices, an enhanced residential gateway (eRG) may perform registration for 5GS and CPN identification. This may include a registration procedure for the eRG and/or a service request procedure for the eRG. Additionally, in the eRG, the user plane of a 5G wireless transmit-receive unit (WTRU) may be handled. This may include a procedure for the eRG for WTRU registration, and/or PDU session establishment for local breakout in the CPN.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example overview of a customer premises network;

FIG. 3 is a diagram illustrating an example of Non-roaming architecture for 5G Core Network for 5G-RG with Wireline 5G Access network and NG RAN;

FIG. 4 is a diagram illustrating an example of AGF in 5G WWC;

FIG. 5 is a diagram illustrating an example of UPF onboarded in the eRG;

FIG. 6 is a diagram illustrating an example of function split alternatives;

FIG. 7 is a diagram illustrating an example of NG N2/N3 Interface;

FIG. 8 is a diagram illustrating an example of User plane Protocols in eRG;

FIG. 9 is a diagram illustrating an example of Control Plane Protocols in eRG;

FIG. 10 is a diagram illustrating an example of WTRU point-of-view control and user plane;

FIG. 11 is a diagram illustrating an example of control plane protocol stack between eRG and 5GC;

FIG. 12 is a diagram illustrating an example of Extended User plane Protocols in eRG;

FIG. 13 is a diagram illustrating an example of a registration procedure for eRG;

FIG. 14 is a diagram illustrating an example of WTRU registration process involving an eRG;

FIG. 15 is a diagram illustrating an example of an aspect of a WTRU registration process;

FIG. 16 is a diagram illustrating an example of an aspect of a WTRU registration process; and

FIG. 17 is a diagram illustrating an example of establishing a default PDU session within a CPN.

### DETAILED DESCRIPTION

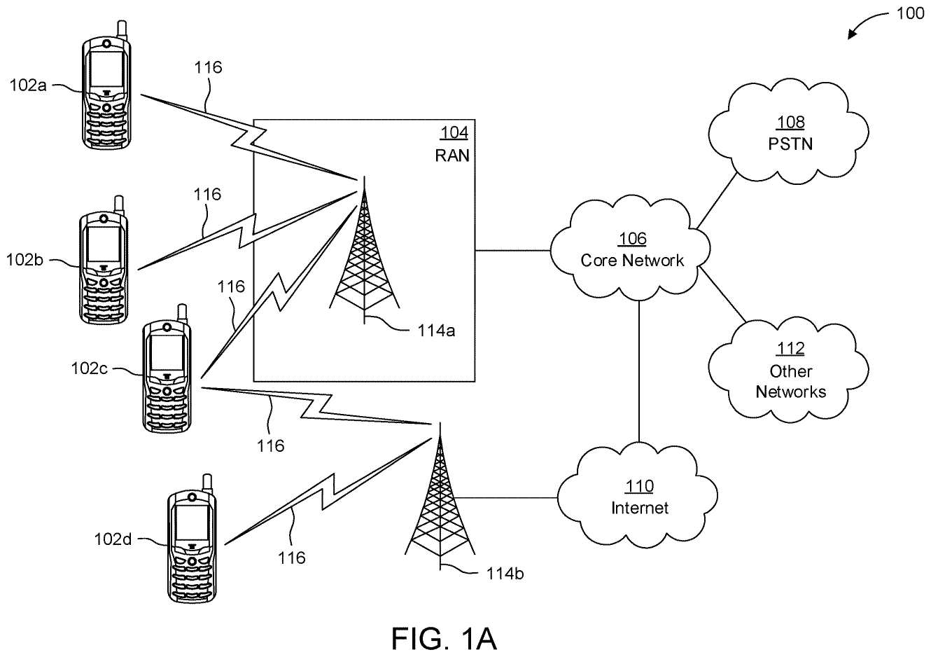

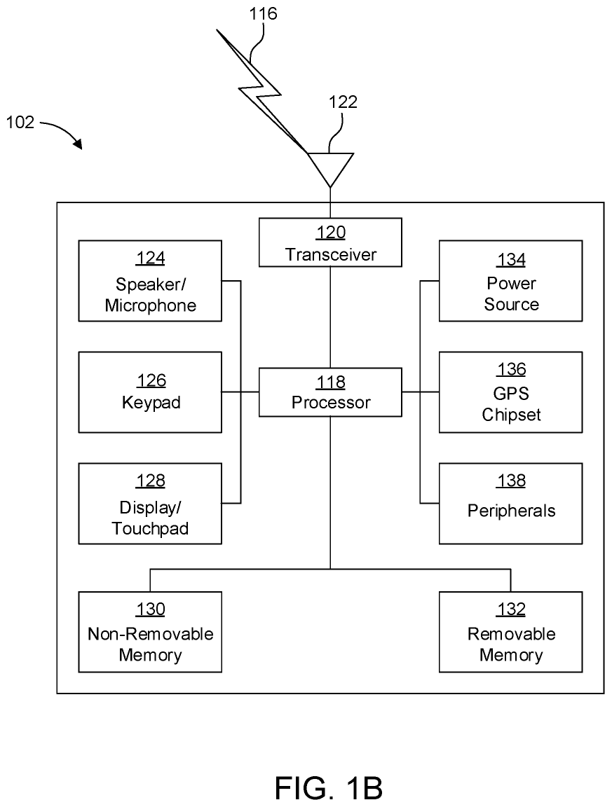

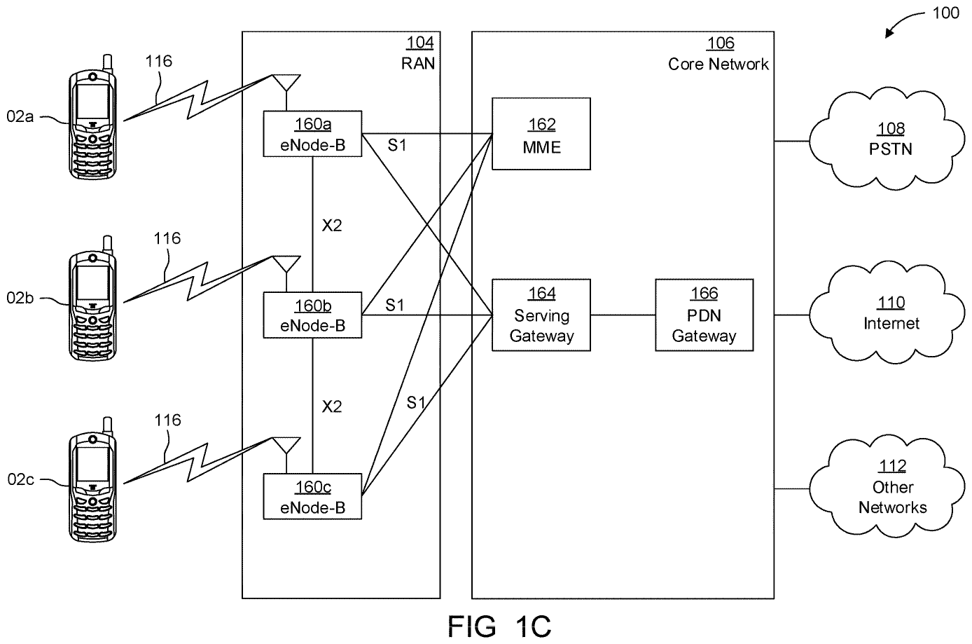

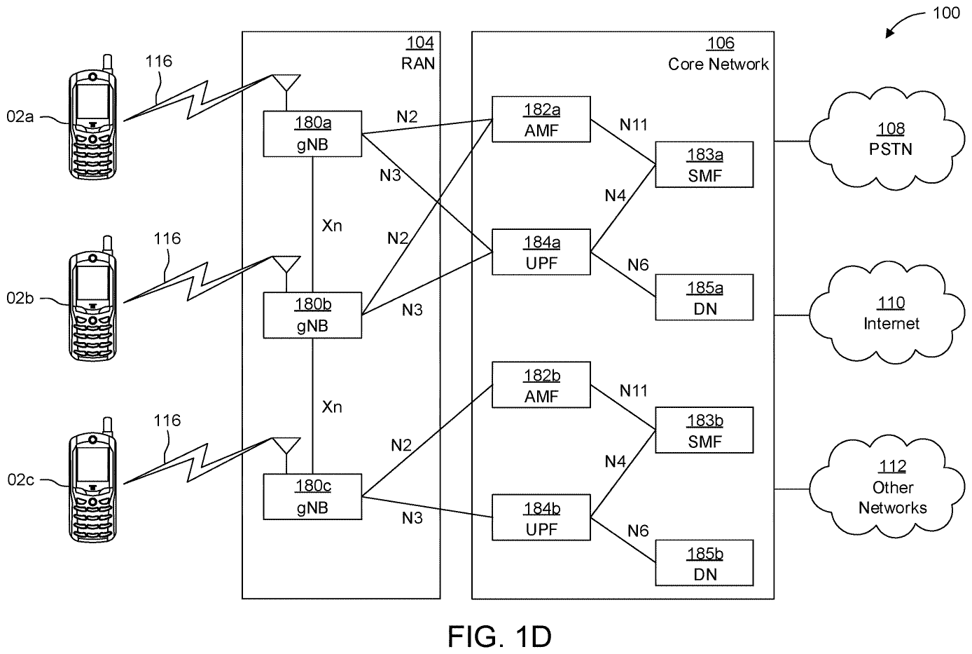

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Generally, reference to the “network” or any other non-entity specific terminology (e.g., 5GC) may inherently refer to one or more devices, nodes, functions and/or base station. These terms may be interchangeable unless otherwise specified.

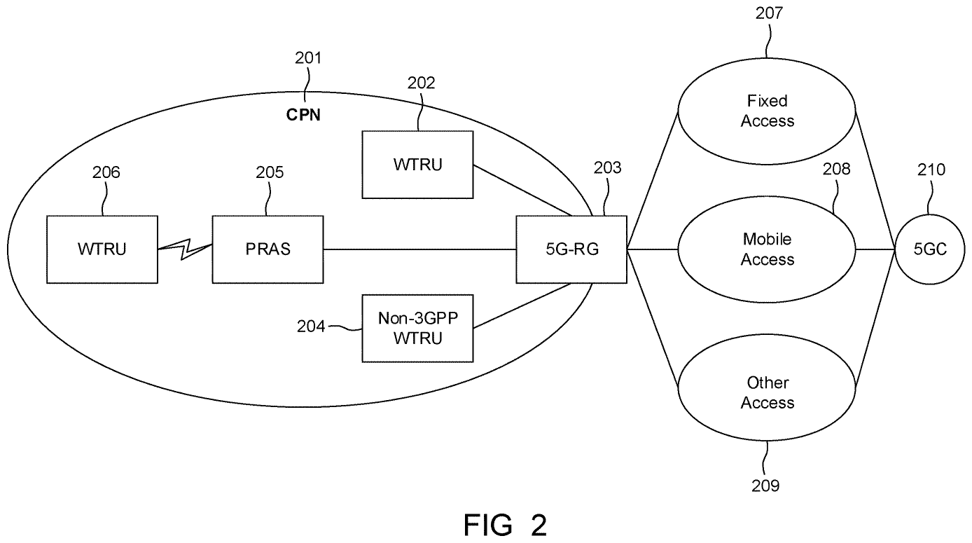

FIG. 2 illustrates an example overview of a customer premises network. In an example scenario, there may be a Residential Gateway (e.g., such as a residential gateway introduced with 5G systems) 203 that connects a Customer Premises Network (CPN) 201 to a core network (e.g., 5GC) 210 via a wireless (e.g., 208), a wireline connection (e.g., 207), and/or some other access (e.g., 209). Generally, CPNs include a set of networking equipment located in a residence, office, or shop that is owned, installed, and/or configured by the customer of a public network provider. This networking equipment(s) can be broadly categorized into Premises Radio Access Station (PRAS) 205, which is similar/same as a home base station, WTRUs 206 that may connect wirelessly to the base station (e.g., with 5G network capability), and Non-3GPP devices 204 that use Non-3GPP access technology to access 5GC (e.g., 802.11 wireless protocols, or other such non-3GPP access). In some cases, a WTRU 202 may have a wired connection to the 5G-RG 203. A user or other entity may be authorized to partially configure and manage a network node in a CPN (e.g., a PRAS or eRG). They may be an Authorized Administrator. A CPN may be owned, installed, and/or (at least partially) configured by the customer of a public network operator.

In some cases, the actual hardware used for a gateway (e.g., enhanced residential gateway, 5G-gateway, etc.) may be similar to or the same as any example of a WTRU listed herein (e.g., or multiple WTRUs used in a distributed manner with a centralized controller). Further, there may be a device at the CPN that serves as multiple entities. For example, the gateway device may also be a (e.g., virtualized in one device, or separate computing units within one hardware apparatus) controller, router, switch, network function, access point, Premises Radio Access Station (PRAS), and/or base station for a specific location.

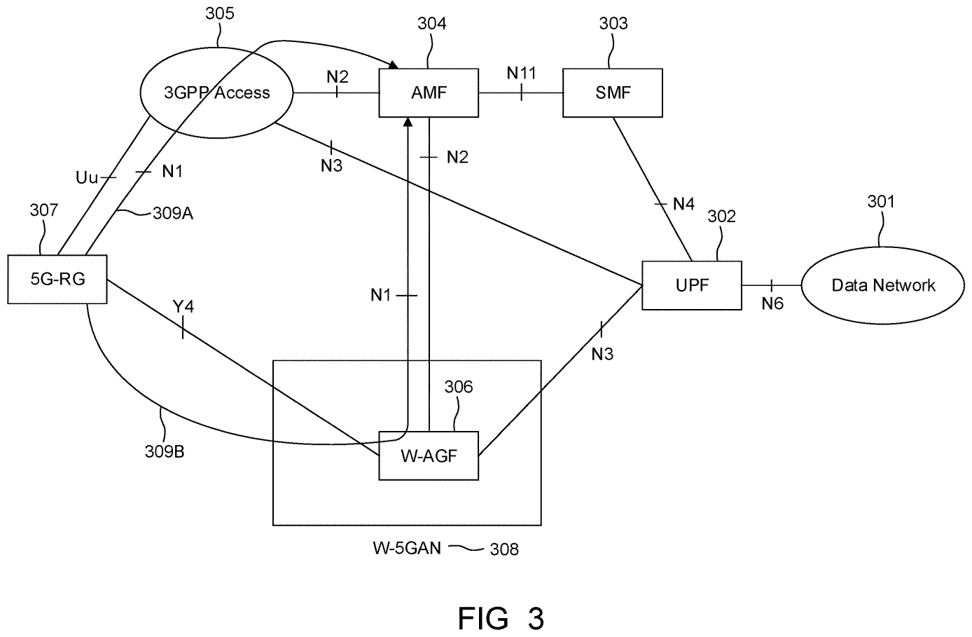

FIG. 3 illustrates an example of a non-roaming architecture for a 5G Core Network for 5G-RG with Wireline 5G Access network and NG RAN. As shown, a 5G-RG 307 may support both wireless 309A and wired 309B connections to 5GC, such as wireless interface (Uu) through Next Generation Radio Access Network (NG-RAN) using 3GPP Access 305 and wireline interface (Y4) through Wireline 5G Access network (W-5GAN) 308 to the 5GC (e.g., such as node AMF 304 of a 5GC). For example, W-5GAN 308 provides N2 interface to AMF 304 and N3 interface to UPF 302 of the 5GC (e.g., similar/same way as a 5G base station); W-5GAN allows untrusted and trusted Non-3GPP WTRUs to connect to 5GC via the Non-3GPPP Inter-Working Function (N3IWF) and Trusted Non-3GPP Gateway Function (TNGF), respectively; and/or, 5G-RG exchanges N1 signaling with 5GC.

In some cases, a 5G-RG may be connected over NG-RAN. The 5G-RG may act as a WTRU connected via NG-RAN, and there may be configurations for network selection, identification and authentication, policy control, lawful interception, authorization access control, and barring of a 5G-RG similar to those for a WTRU.

In some cases, a 5G-RG may be connected over W-5GAN. A 5G-RG may act as a WTRU connected via W-5GAN and initiate a Protocol Data Unit (PDU) session, and request quality of service (QoS) from the 5GC. An individual PDU session may serve multiple WTRUs behind the 5G-RG and may implement connectivity to the 5GC at the granularity of one PDU session per slice.

The 5G-RG may first register with an AMF to establish a PDU session. The PDU session may contain several QoS flows to support the assorted services provided by the 5G network. The data from a data network passes through the N6 interface to UPF, which may then be forwarded via the N3 interface to the W-5GAN using the GPRS Tunnelling Protocol (GTP). Onwards from this point, the 5G-RG may transfer the information to multiple WTRUs behind the 5G-RG using ethernet or Wi-Fi access within the CPN.

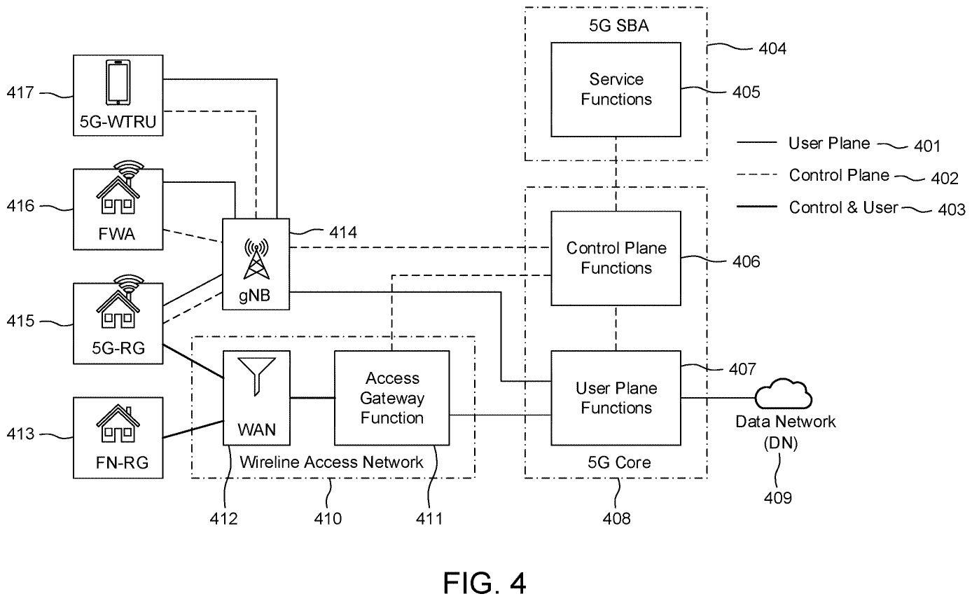

FIG. 4 illustrates an example of an Access Gateway Function (AGF) in 5G wireline and wireless convergence (WWC). In some cases, wireline and wireless may have one or more points of convergence. With the wireline access capability to 5GC, current broadband services may get internet access through a 5G-RG. Considering the potential of future use cases for devices at a CPN, there is a need to define services and systems required to support wireless and wireless convergence (WWC) in a 5G system. These specifications may define an Access Gateway Function (AGF) capable of providing AAA (authentication, authorization, and accounting) services, traffic shaping, and policing for a fixed network (FN) and 5G-RGs from a standard 3GPP user plane function within a common 5GC as shown in FIG. 4. For example, the AGF 411 may have a user plan connection to the UPF 407 of the 5GC 408, which in turn connects to a data network 409. The AGF 411 may be a part of a wireline access network 410 that connects with control and user signaling to a WAN 412, which in turn connects to other residential gateways (e.g., 5G-RG 415 and FN-RG 413). In an example scenario, the 5G-RG 415 may also be connected to a base station (e.g., gNB 414), which in turn is connected to the CPF 406 of the 5GC 408.

Generally, given that there is a growing number of uses for residential 5G, such as bringing new experiences to users at home, leading 5G vendors may work to continuously improve their residential 5G solutions. For example, one scenario may be using mid-band spectrum (2.5 GHz and 3.5 GHz) and high gain antennas for enhancing the capacity and coverage of fixed wireless access compared to traditional LTE-based fixed wireless solutions. Another scenario, which may have 180 million fixed wireless access connections by the end of the year 2026, provides CPNs with 5G access enabling high capacity and robust QoS features. In another scenario, a fixed wireless coverage may be extended up to 7 kilometers over a 26 GHz mmWave frequency connection.

Over 70 percent of mobile network operators around the world are now offering both mobile and fixed network services. A few examples of these services include fixed networks, broadband Internet, mobile communication, and IPTV. With the WWC initiative, network operators may be able to optimally integrate the provision of these services via a common 5GC. Along with the other benefits of 5G, such as the increased data rates, ultra-low latency, enhanced reliability, etc., the use of a common 5GC may reduce the maintenance expenditures of the network operator providing quadruple-play services.

Mobile network operators with single-play services may also benefit from 5G residential services. One of the example benefits that 5G brings to consumers is that it will provide higher bitrates. These higher bitrates may enable or improve eMBB services such as mobile TV, ARNR, or mobile gaming. Remarkably such “mobile” services may be mostly used by users who are not on the move but possibly mobile/stationary at a specific location (e.g., home residence). Besides higher bitrates, ultra-low latency and enhanced reliability may enhance the user experience for ARNR, Gaming, Monitoring, and Security applications. 5G residential gateway may serve as a platform for future localized services, home entertainment, ARNR, etc., enabling 5G+/6G use cases.

There may be a plurality of use cases and traffic scenarios in residential environments and which may require related new potential functional/key performance requirements to support the enhancements for WWC, fixed LAN-5GLAN integration, and indoor small base stations. Some of these use cases are summarized herein.

In one example case, there may be efficient Routing for WTRU-to-WTRU Communications via eRG: This use case assumes that there are multiple PRAS already deployed in the rooms behind the eRG to provide better cellular coverage at home. This use case enables efficient routing for the communications between two WTRUs via the eRG. For example, Alice is sitting in the attic, and her smartphone is connected to the PRAS in the attic. The security sensor detects fire and smoke in the basement and then sends Alice an alert. Through the basement PRAS, the alarm message reaches the eRG, which then routes it to Alice's smartphone through the attic PRAS. This use case highlights a “switching element” in eRG, which may switch local traffic between 3GPP devices as well as between 3GPP and non-3GPP devices.

In one example case, there may be E2E QoS monitoring: This use case assumes that there are multiple PRAS already deployed in the rooms behind the eRG to provide better cellular coverage at home. This use case enables E2E QoS monitoring for the whole communication path, i.e., from/to a WTRU to/from the 5GC via a PRAS and an eRG. For example, Alice is sitting in the living room, and her smartphone is connected to the PRAS in the living room. She begins video streaming in real-time from the video application server in the cloud. After a while, the download speed slows down, and the video stream stops. Alice calls the network operator and reports the network performance decline. When the network operator checks the E2E QoS status, it detects high interference on PRAS and reconfigures PRAS to recover E2E QoS. This use case highlights the capability of eRG to measure observed QoS for an individual user and take actions to set QoS for that user. How eRG measures and sets QoS for individual users is addressed herein.

In one example case, there may be QoS Maintenance from Outdoors to Indoors: Due to the issue of 5G outside-to-inside coverage, WTRUs may access 5GC through an eRG when moving from outdoors to indoors. This use case enables an all-way QoS control guarantee when an ongoing high bandwidth or low latency consuming service (e.g., video gaming) user moves from outdoors to indoors. For example, Tom is playing a video game on his smartphone on his way back home. When Tom arrives home, he keeps on playing the game while he enters his house. As Tom enters the house, his smartphone is identified and connected to the eRG. The eRG is also informed of the relevant QoS characteristics of Tom's smartphone at this moment, and the 5GS provides corresponding QoS to Tom. This use case highlights how Tom is identified in the 3GPP 5GC and continues to be identified as he moves inside the home. His service is continued with the desired level of QoS. eRG is expected to identify Tom and provide the same QoS as he moves inside the house.

In one example case, there may be a Seamless Path Switch from a WTRU-to-WTRU Direct Communication to Indirect Communication via an eRG: This use case enables two WTRUs to seamlessly switch from a direct communication path to an indirect communication path via an eRG as the distance between WTRUs increases. For example, two WTRUs (WTRU1 and WTRU2) are connected via a 3GPP direct communication path. An event occurs that triggers WTRU1 to move away from WTRU2. To continue their service seamlessly with the same QoS, an indirect communication path via an eRG is established.

To support the use cases described herein, and others, the following requirements have been identified for an eRG: a 5G system may support authentication of a WTRU with 3GPP credentials for communication with entities (WTRUs, devices) in a CPN; a 5G system may support an efficient data path through an eRG for intra-CPN data traffic to or from a WTRU; a 5G system may support real-time E2E QoS monitoring and control for any intra-CPN data traffic to or from a WTRU (e.g., via eRG or PRAS and eRG); a 5G system may support real-time E2E QoS monitoring and control for any data traffic between a WTRU within a CPN and the 5G network (e.g., via eRG or PRAS and eRG); a 5G system may minimize service disruption for a WTRU moving between CPN access and operator-provided mobile access; a 5G system may support a mechanism for the network operator to provision an eRG with one or more parameters (e.g., policies on which transport (e.g., wireless, cable, etc.) is best suited for different negotiated QoS levels, authentication credentials, identification, initial OA&M information, and/or associated subscription); a 5GS may enable the network operator to provide 5G services to any WTRU via a PRAS connected via an eRG; and/or, a 5GS may support applications on an Application Server connected to the CPN. One or more of these requirements may require: Identification and visibility of the WTRUs by 5GC; Capability for enforcing more granular QoS for each WTRU; and/or, Individual policy enforcement per WTRU, link or application service, etc.

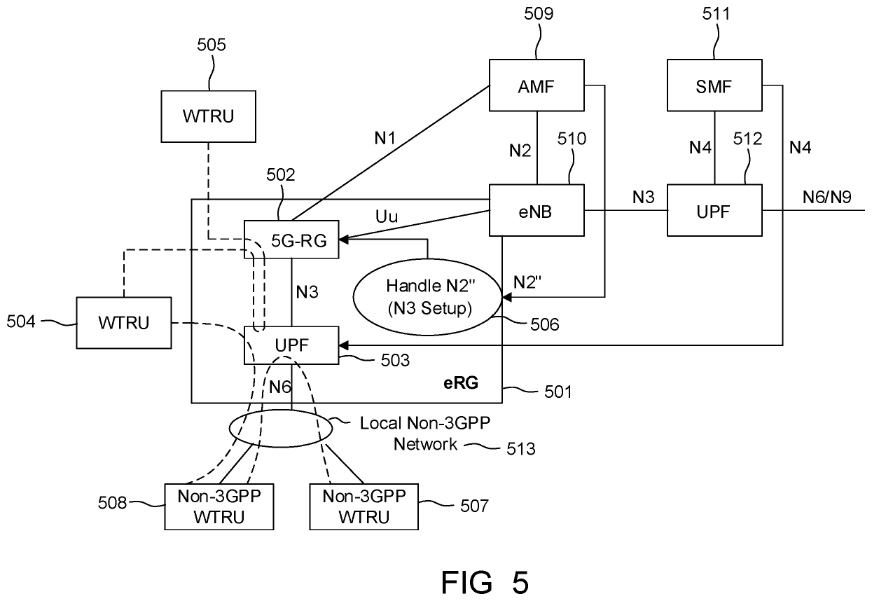

FIG. 5 illustrates an example of a user plane function (UPF) onboarded in an enhanced residential gateway (eRG). As shown, eRG 501 may include various functions in addition to 5G-RG 502, such as UPF 503. For illustration purposes, the dotted lines may indicate an example data flow path, and the solid lines may indicate a connection and/or interface. The eRG 501 may be expected to differentiate the QoS requirements for each WTRU (e.g., 504, 505, 507, 508) connected via its interface to the 5GC.

According to one example of eRG architecture, the WTRUs behind the eRG may not be identified independently; instead, a PDU session identifies them as a slice. The eRG may be able to differentiate each WTRU's QoS requirements in order to access the respective QoS flows from the 5GC in order to provide a consistent and policy-driven service experience. 5GC is capable of enforcing QoS control and policy through SMF and UPF. The functional requirements defined above may be satisfied if functions like SMF and UPF are onboarded in the eRG (e.g., as illustrated in part in FIG. 5). Onboarding a UPF and a SMF to an eRG may allow for the identifying of individual user plane(s), taking measurements on the user plane, and setting QoS parameters for desired user experience. This is an architectural assumption that may be made for one or more embodiments described herein.

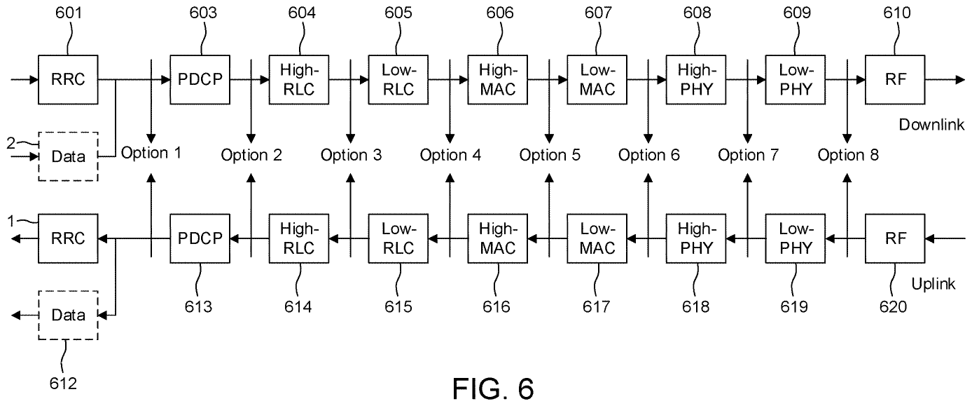

FIG. 6 illustrates an example of function split alternatives. There may be one or more deployment options for an eRG that involve the splitting of functions. In some cases, eRG and PRAS architecture may employ split function techniques. In one example deployment option, eRG and PRAS scenarios may be similar to the split architecture of distributed base stations (e.g., gNB) in a network (e.g., NG-RAN). In the distributed gNB architecture, the centralized unit base station (e.g., gNB-CU) controls one or more distributed units (gNB-DU) through the F1 interface. The distributed unit is connected to a remote radio head (RRH), a remote radio transceiver. The gNB-CU is split into two parts, one for control plane functions (gNB-CU-CP) and one for user plane functions (gNB-CU-UP). As shown, 601-620 illustrates different layers of processing in an example uplink or downlink process. This functional splitting may be made at any of the eight split options shown in between each layer (e.g., Option 1-8) of the UL/DL. PRAS may be assumed as the gNB-DU and eRG as the gNB-CU. The exact point of splitting may be left open for implementation. In at least one embodiment discussed herein, the CU-UP and CU-CP techniques may be employed with the eRG.

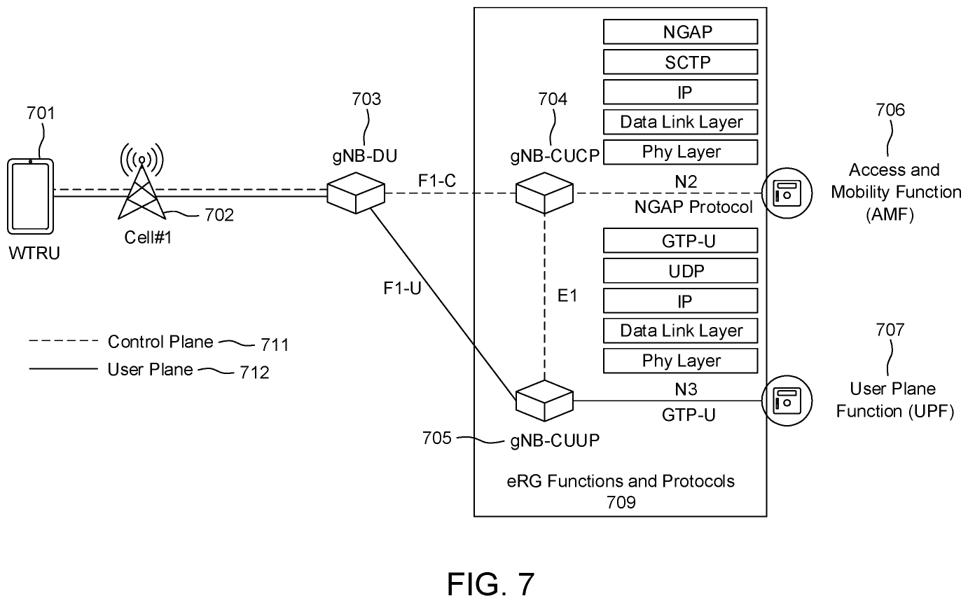

FIG. 7 illustrates an example of NG N2/N3 interface. There may be a WTRU 701 with a connection to cell 702, which in turn is connected to the network employing a split function architecture system. This example demonstrates a deployment of a control plane 711 and a user plane 712 in an eRG 709. The techniques described with regard to FIG. 6 apply equally to the illustration of FIG. 7.

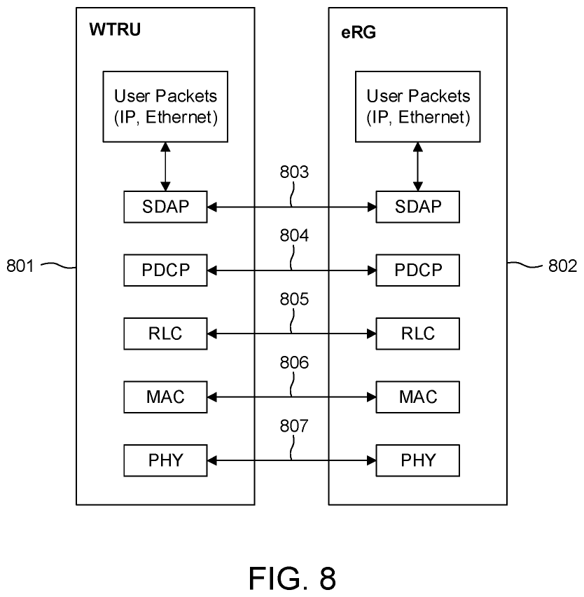

FIG. 8 illustrates an example of User Plane Protocols in an eRG. For user plane deployment options, an example of the protocol stack for the user plane from WTRU 801 to eRG 802 is shown. These protocol stacks (e.g., 803-807) are for illustration of the user plane only, without detailing the splits. The user plane protocols may implement the actual PDU session service, such as carrying user data through the access stratum. It may be assumed that the user plane would be terminated in the eRG to allow local routing to the CPN. The SDAP 803 layer in the user plane stack may be assumed to be the termination point in the eRG. To summarize, in some examples where a central unit user plane (CU-UP) technique is considered for a WTRU, then: there may be a GTP-U/N3 towards the local UPF over a local data link; and/or, a WTRU may act as a RELAY, and forward the UP packet over the user plane it establishes with 5GC (e.g., through the eRG).

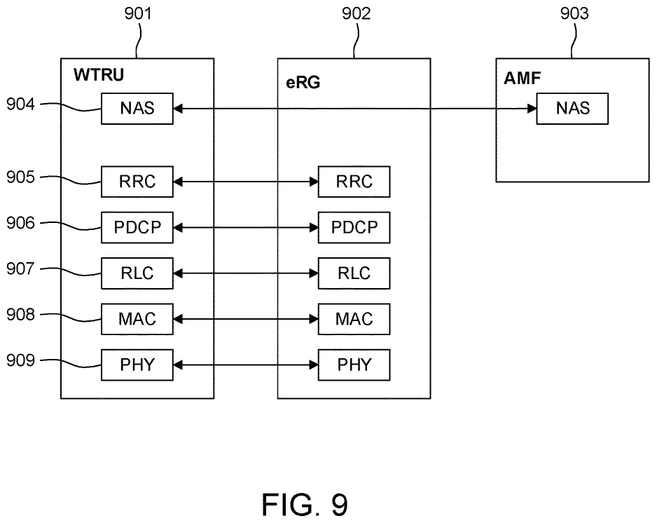

FIG. 9 illustrates an example of Control Plane Protocols in eRG. For control plane options, an example control plane protocol stack for WTRU 901 to the 5GC (e.g., AMF 903) through the eRG 902 is shown. The control plane protocols may control the PDU sessions and the connection between the WTRU 901 and the 5GC. It may support setting up the requested service by a user (e.g., WTRU 901), controlling different transmission resources, handover, and the like. As shown, the eRG may forward NAS messages from the WTRU 901 to the 5GC/AMF 903. In some examples, CU-CP deployment options may be possible for a WTRU, where: the NGAP/N2 over the user plane may be established by the eRG with 5GC; and/or, the NAS-MM messages may be transparently transferred between the WTRU and the NG-RAN over the eRG (e.g., eRG acts as RELAY node).

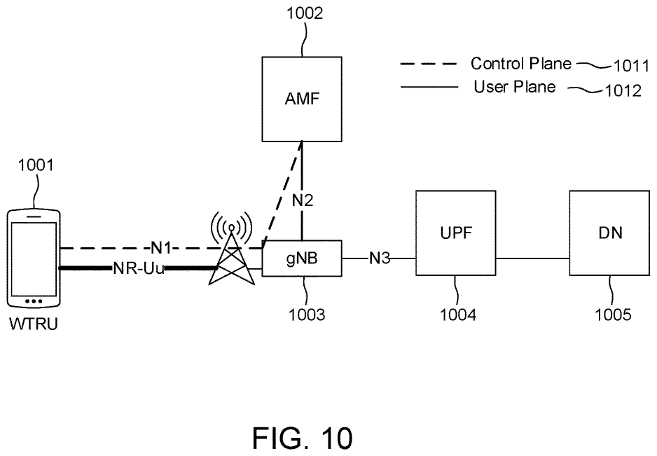

FIG. 10 illustrates an example of a WTRU point-of-view control plane and user plane. As shown, the WTRU 1001 has a control plane 1012 link to the base station (e.g., gNB 1003), where the control plane extends to the AMF 1002. The user plane 1011 extends from the base station through the UPF 1004 and to the DN 1005. In some cases, there may be a transparent transfer of NAS-MM message options for a WTRU inside the CPN. The transparent transfer of NAS-MM message may happen over the N1 interface towards 5GC, setup by eRG, which is a WTRU for its own use. FIG. 10 shows the logical N1 interface from the WTRU 1001 to the AMF 1002, which may be used to transfer NAS messages from the WTRUs inside the CPN. The Nr-Uu may carry both control plane and user plane from the WTRU. Then the user plane goes out from base station towards the DN over N3, N6/N9.

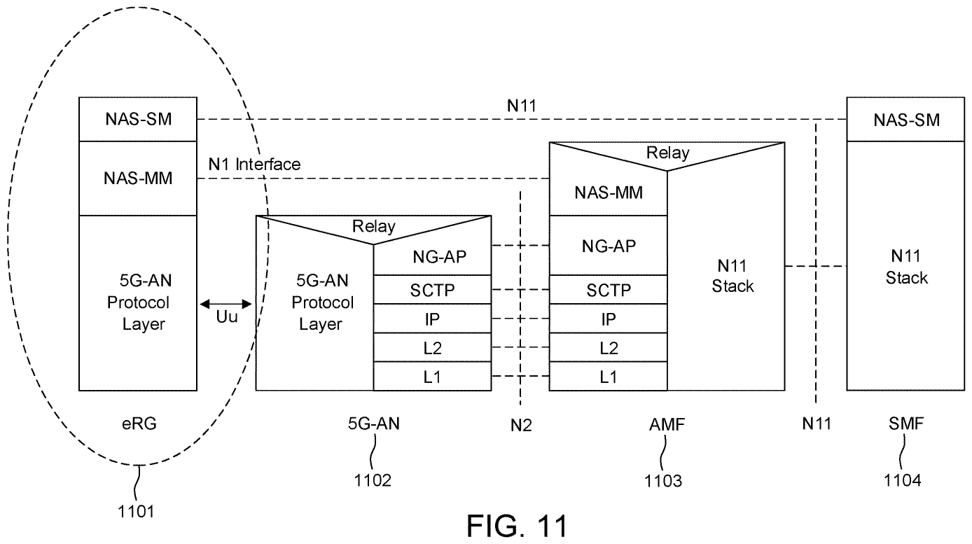

FIG. 11 illustrates an example of a control plane protocol stack between eRG and 5GC. There may be an eRG 1101, 5G-AN 1102, AMF 1103, and an SMF 1104. In this example, the eRG 1101 may be assumed to deploy the following control plane protocols, as shown, to support N1 interface. N1 is the control plane interface with AMF 1103, whose messages are delivered via NR-Uu and N2 interfaces through the gNB. An N1 NAS signaling connection is either the concatenation of an RRC connection via the Uu reference point and an NG connection via the N2 reference point for 3GPP access or the concatenation of an IPsec tunnel via the NWu reference point and an NG connection via the N2 reference point for non-3GPP access.

The NAS protocol for MM functionality (NAS-MM) may support registration management functionality, connection management functionality, and user plane connection activation and deactivation. It may also be responsible for ciphering and integrity protection of NAS signaling.

Based on one or more of the architectural scenarios discussed herein, one or more of the following problems may be addressed: eRG registration and CPN identification; and/or handling of UP termination from WTRU and CPN in eRG.

The eRG or any user device, such as a WTRU, may be capable of providing CPN service. Generally, and especially in PIN networks, it may be beneficial if personal devices are capable of providing CPN service. Thus, CPN may be viewed as a service provided by any user device. In order to enable user devices to provide CPN service, one or more approaches are considered (as discussed herein): How does a CPE join 5GC and inform about its capability and pre-configuration (e.g., by the Authorized Administrator) to provide CPN service? What does the 5GC do to enable/allow the CPE to provide CPN service? What configuration information needs to be provided? How is the CPN identified by 5GC? How may the CPN service be continued when the anchor CPE moves out of the premise? And the like.

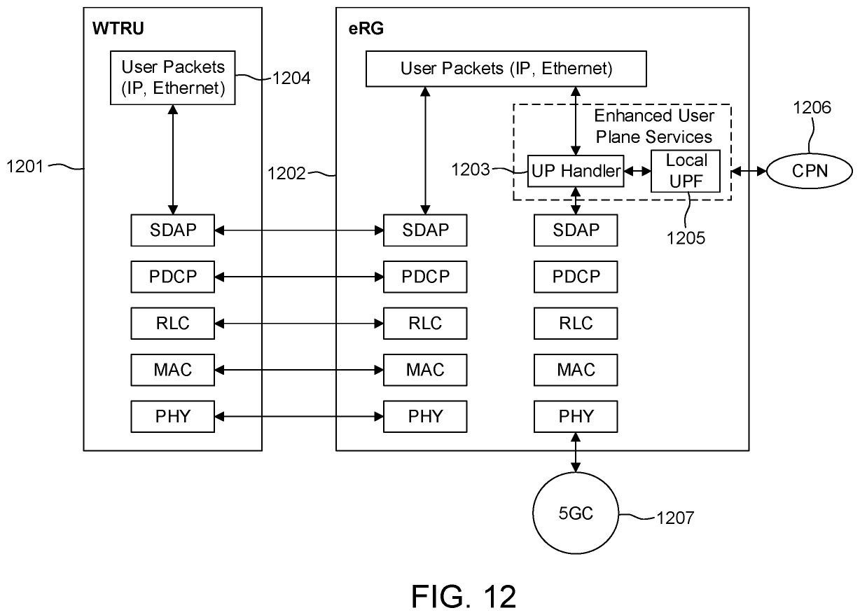

FIG. 12 illustrates an example of Extended User plane Protocols in eRG. As shown, there is an example of the termination of the user plane from the WTRU 1201 to the eRG 1202. The SDAP protocol on the left side is the termination point where user plane packets are available. The user plane packet may be forwarded to either 5GC 1207 or CPN 1206. The diagram shows enhanced user plane services in a dotted box (e.g., comparable/similar to a switching function), which may include the UP handler 1203, which makes the decision, and the local UPF 1205. These enhanced user plane services may represent one of the enhancements to a residential gateway. The eRG may handle forwarding of user plane packets towards 5GC and CPN and may use one or more functions that were previously external to a residential gateway to do so. The 5GC may configure one or more aspects of the eRG, in order to, for example, allow the forwarding of packets between 5GC and CPN.

For eRG/CPN registration and identification, the eRG may be seen as a WTRU-type device from the perspective of the 5GC and may consequently register with the 5G network, provide capability information, and perform other related actions. The eRG may be partially configured by an Authorized Administrator. The eRG may handle (e.g., determine, route, switch, etc.) communication that is routed to the 5G-AN, as well as communication that is routed locally toward the CPN. The eRG can provide Home PLMN and a Local PLMN service, which allows reaching destinations within the customer premise network. The eRG may register with the 5GS to provide Local PLMN service. Afterward, when a local WTRU registers with the 5GC, the WTRU may be provided with available PLMNs, such as Home PLMN and a Local PLMN. The local WTRU may register with both PLMNs. The 5GC may provide configuration information to the WTRU in the CPN, using NAS messages over N1.

For management of the user plane from a WTRU and CPN, the 5GC may maintain one or more lists of CPN_IDs->DEVICE_ID (e.g., currently registered and/or active) subscriptions. The WTRU may initiate user plane setup towards: another WTRU or Non-3GPP Device in the CPN; and/or, another WTRU in the operator network. 5GC may use the N1-eRG interface to instruct how the user plane needs to be forwarded. For example, the WTRU may request to connect to a specific WTRU that is not connected to a CPN. The 5GC may instruct the WTRU to connect to CPN and set up the user plane.

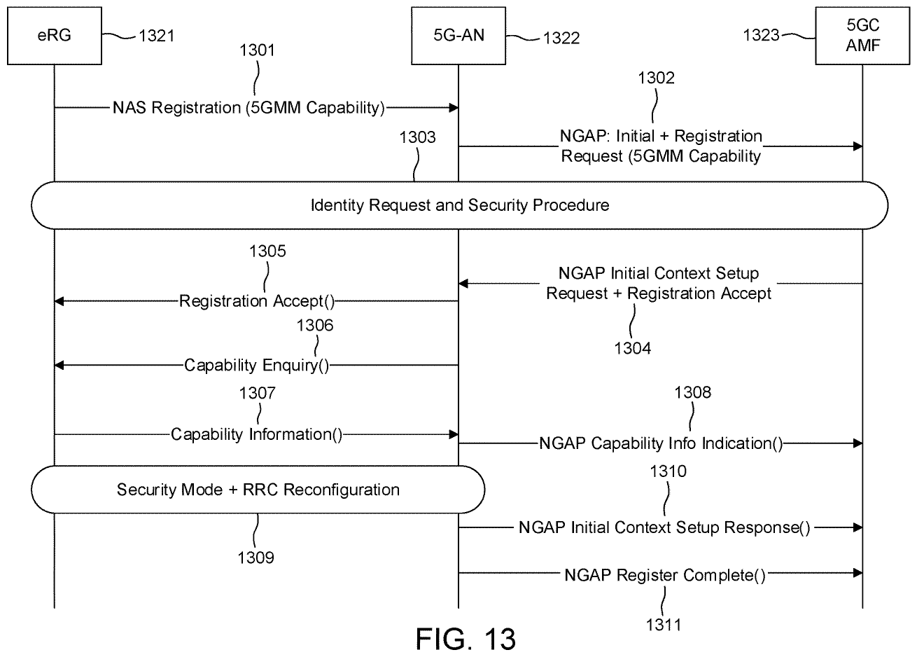

FIG. 13 illustrates an example of a registration procedure for eRG. As illustrated, there is an eRG 1321, a 5G-AN 1322, and a 5GC/AMF 1323. At 1301, eRG sends a transmission that includes “5G CPN” Capability as part of an updated “5GMM capability” in the Registration Request message. The “5G CPN Capability” indicates the pre-configuration information by the network operator and/or an Authorized Administrator: Configurable CPN Name or CPN ID (e.g., 5GC may provide a configurable “CPN-PLMN”, which may be used by PRAS or N3IWF); 5G non-3gpp Remote WTRU using N3IWF; Offloading to CPN->Local UPF or other; local service information, such as local DNN; QoS capability within CPN; use of unlicensed spectrum by the PRAS connected to the eRG; and/or, support of visitor access

TABLE 1
shows an example of details of 5GMM capability IE

| 8 | 7 | 6 | 5 | 4 | 3 | 2 | 1 | |
|---|---|---|---|---|---|---|---|---|
| 5GMM capability IEI | | | | | | | | octet 1 |
| Length of 5GMM capability contents | | | | | | | | octet 2 |
| SGC | 5G-IPHC- | N3 data | 5G-CP | RestrictEC | LPP | HO attach | S1 mode | octet 3 |
| | CP CIoT | | CIoT | | | | | |
| RACS | NSSAA | 5G-LCS | V2XCNPC5 | V2XCEPC5 | V2X | 5G-UP | 5GSRVCC | octet 4* |
| | | | | | | CIoT | | |
| ProSe- | ProSe-dc | ProSe-dd | ER-NSSAI | 5G-EHC- | multipleUP | WUSA | CAG | octet 5* |
| l2relay | | | | CP CIoT | | | | |
| Configurable | Offloading | Local | CPN with | CPN with | ProSe- | ProSe- | ProSe- | octet 6* |
| CPN | to CPN | DNN | UPF | RELAY | l3rmt | l2rmt | l3relay | |
| 0 | 0 | 0 | 0 | 0 | Use of | NWIF | Visitor | octet 7 |
| | | | | | unlicensed | support | access | |
| | | | | | spectrum | | support | |
| 0 | 0 | 0 | 0 | 0 | 0 | 0 | 0 | octet 8*-15* |

Spare

There may be one or more capability information bits. For example, Configurable CPN Name: Allows 5GC to be aware that eRG may support configurable and more than one CPN_Name to enable different services and service levels for each CPN_Name. The “CPN with UPF” bit indicates the capability for CPN communication which allows the eRG to switch the traffic originating from WTRUs behind the eRG to local UPF. The “CPN with RELAY” bit indicates the capability for CPN communication which allows the eRG to relay the traffic originating from WTRUs behind the eRG to 5GC. The Offloading to CPN indicates the capability to offload the incoming traffic to local UPF. The N3IWF support indicates the capability to allow untrusted non-3GPP access users to connect to 5GC via eRG. The Local DNN capability indicates the capability to connect to local or external IP networks via the eRG. The 5GC may use QoS capability within CPN capability to prioritize specific service data flows to provide the expected QoS. The “Use of unlicensed spectrum” indicates the capability of using the unlicensed spectrum within the PRAS(s) connected to the eRG. The “Visitor access support” bit indicates whether the eRG/PRAS supports access for all or no visitors, or allows specific visitors only. This capability may be pre-configured by the Authorized Administrator (e.g., subject to the operator's policy).

At 1302, the Registration Request message may be forwarded to AMF.

At 1303, there may be one or more message exchanges related to identity requests and/or security procedures.

In some instances, the AMF may store the “5G CPN” Capability for 5G CPN operation. The AMF may obtain the “5G CPN” subscription data as part of the user subscription data from the UDM during the eRG Registration procedure using Nudm_SDM service. The AMF may determine whether the eRG is authorized to provide 5G CPN services based on eRG's 5G CPN Capability along with the pre-configuration by the Authorized Administrator and the “CPN Service Authorization” included in the subscription data received from UDM. The AMF may store the authorized “5G CPN” Capability. The AMF may send the authorized 5G CPN Capability for 5G CPN operation to PCF. Based on the received 5G CPN Capability from the AMF, the PCF may provide QoS parameters to AMF for: 3GPP devices within the CPN; Non-3GPP devices within the CPN; Service specific QoS; and/or, Promised QoS for eRG. The AMF may store such information as part of the eRG context.

At 1304, the AMF may initiate a session setup with the gNB (e.g., of the 5G-AN 1322). The message may contain the Registration Accept NAS message. The message may carry one or more PDU session setup requests. Each PDU session may be addressed with the “PDU Session ID”. The message may also carry the uplink TEID for every PDU session.

Additionally/alternatively, the AMF may send with the session setup message e.g. “Initial Context Setup Request” or in a separate message a NGAP message, e.g. “Registration Accept” message to the NG-RAN, if the eRG is authorized to use “5G CPN authorized” information, including one or more of the following: QoS details as part of erg context; CPN_PLMN_ID; whether eRG is authorized to act as a 5G Layer-2 WTRU-to-Network Relay; and/or, whether the eRG is authorized to act as a 5G ProSe Layer-3 WTRU-to-Network Relay.

The purpose of the “Initial Context Setup” procedure may be to establish the necessary overall initial eRG Context at the NG-RAN node, when required, including: PDU session context from eRG (e.g., CPN relay L3/2 ETC); Security Key; Mobility Restriction List, eRG Radio Capability; and/or, eRG Security Capabilities.

At 1305, the 5G AN may send a Registration Accept message to the eRG, which may include CPN configuration, such as PLMN ID/CPN ID to the eRG, and/or Radio parameters used in CPN.

Table 2 is an example of details of registration accept message

| IEI | Information Element | Type/Reference | Presence | Format | Length |
|---|---|---|---|---|---|
| | Extended protocol | Extended protocol discriminator | M | V | 1 |
| | discriminator | 9.2 | | | |
| | Security header type | Security header type | M | V | ½ |
| | | 9.3 | | | |
| | Spare half octet | Spare half octet | M | V | ½ |
| | | 9.5 | | | |
| | Registration accept message | Message type | M | V | 1 |
| | identity | 9.7 | | | |
| | 5GS registration result | 5GS registration result | M | LV | 2 |
| | | 9.11.3.6 | | | |
| 77 | 5G-GUTI | 5GS mobile identity | O | TLV-E | 14 |
| | | 9.11.3.4 | | | |
| | CPN_Info | 5GS CPN info | | | |
| | Struct | | | | |
| | { | | | | |
| | PLMN ID, CPN ID, Cells to be | | | | |
| | added/modified, Cells to be | | | | |
| | activated/de-activated | | | | |
| | } | | | | |
| 4A | Equivalent PLMNs | PLMN list | O | TLV | 5-47 |
| | | 9.11.3.45 | | | |
| 54 | TAI list | 5GS tracking area identity list | O | TLV | 9-114 |
| | | 9.11.3.9 | | | |
| 15 | Allowed NSSAI | NSSAI | O | TLV | 4-74 |
| | | 9.11.3.37 | | | |
| 11 | Rejected NSSAI | Rejected NSSAI | O | TLV | 4-42 |
| | | 9.11.3.46 | | | |
| 31 | Configured NSSAI | NSSAI | O | TLV | 4-146 |
| | | 9.11.3.37 | | | |
| 21 | 5GS network feature support | 5GS network feature support | O | TLV | 3-5 |
| | | 9.11.3.5 | | | |
| 50 | PDU session status | PDU session status | O | TLV | 4-34 |
| | | 9.11.3.44 | | | |
| 26 | PDU session reactivation result | PDU session reactivation result | O | TLV | 4-34 |
| | | 9.11.3.42 | | | |
| 72 | PDU session reactivation result | PDU session reactivation result | O | TLV-E | 5-515 |
| | error cause | error cause | | | |
| | | 9.11.3.43 | | | |
| 79 | LADN information | LADN information | O | TLV-E | 12-1715 |
| | | 9.11.3.30 | | | |
| B- | MICO indication | MICO indication | O | TV | 1 |
| | | 9.11.3.31 | | | |
| 9- | Network slicing indication | Network slicing indication | O | TV | 1 |
| | | 9.11.3.36 | | | |
| 27 | Service area list | Service area list | O | TLV | 6-114 |
| | | 9.11.3.49 | | | |
| 5E | T3512 value | GPRS timer 3 | O | TLV | 3 |
| | | 9.11.2.5 | | | |
| 5D | Non-3GPP de-registration | GPRS timer 2 | O | TLV | 3 |
| | timer value | 9.11.2.4 | | | |
| 16 | T3502 value | GPRS timer 2 | O | TLV | 3 |
| | | 9.11.2.4 | | | |
| 34 | Emergency number list | Emergency number list | O | TLV | 5-50 |
| | | 9.11.3.23 | | | |
| 7A | Extended emergency number | Extended emergency number list | O | TLV-E | 7-65538 |
| | list | 9.11.3.26 | | | |
| 73 | SOR transparent container | SOR transparent container | O | TLV-E | 20-n |
| | | 9.11.3.51 | | | |
| 78 | EAP message | EAP message | O | TLV-E | 7-1503 |
| | | 9.11.2.2 | | | |
| A- | NSSAI inclusion mode | NSSAI inclusion mode | O | TV | 1 |
| | | 9.11.3.37A | | | |
| 76 | Operator-defined access | Operator-defined access | O | TLV-E | 3-8323 |
| | category definitions | category definitions | | | |
| | | 9.11.3.38 | | | |
| 51 | Negotiated DRX parameters | 5GS DRX parameters | O | TLV | 3 |
| | | 9.11.3.2A | | | |
| D- | Non-3GPP NW policies | Non-3GPP NW provided policies | O | TV | 1 |
| | | 9.11.3.36A | | | |
| 60 | EPS bearer context status | EPS bearer context status | O | TLV | 4 |
| | | 9.11.3.23A | | | |
| 6E | Negotiated extended DRX | Extended DRX parameters | O | TLV | 3 |
| | parameters | 9.11.3.26A | | | |
| 6C | T3447 value | GPRS timer 3 | O | TLV | 3 |
| | | 9.11.2.5 | | | |
| 6B | T3448 value | GPRS timer 2 | O | TLV | 3 |
| | | 9.11.2.4 | | | |
| 6A | T3324 value | GPRS timer 3 | O | TLV | 3 |
| | | 9.11.2.5 | | | |
| 67 | WTRU radio capability ID | WTRU radio capability ID | O | TLV | 3-n |
| | | 9.11.3.68 | | | |
| E- | WTRU radio capability ID | WTRU radio capability ID deletion | O | TV | 1 |
| | deletion indication | indication | | | |
| | | 9.11.3.69 | | | |
| 39 | Pending NSSAI | NSSAI | O | TLV | 4-146 |
| | | 9.11.3.37 | | | |
| 74 | Ciphering key data | Ciphering key data | O | TLV-E | 34-n |
| | | 9.11.3.18C | | | |
| 75 | CAG information list | CAG information list | O | TLV-E | 3-n |
| | | 9.11.3.18A | | | |
| 1B | Truncated 5G-S-TMSI | Truncated 5G-S-TMSI | O | TLV | 3 |
| | configuration | configuration | | | |
| | | 9.11.3.70 | | | |
| 1C | Negotiated WUS assistance | WUS assistance information | O | TLV | 3-n |
| | information | 9.11.3.71 | | | |
| 29 | Negotiated NB-N1 mode DRX | NB-N1 mode DRX parameters | O | TLV | 3 |
| | parameters | 9.11.3.73 | | | |
| 68 | Extended rejected NSSAI | Extended rejected NSSAI | O | TLV | 5-90 |
| | | 9.11.3.75 | | | |
| 7C | Service-level-AA container | Service-level-AA container | O | TLV-E | 6-n |
| | | 9.11.2.10 | | | |

The eRG may use the “CPN_Info” to configure itself and PRAS.

The following PRAS configurations may be performed: the PLMN ID and CPN ID are set in PRAS to be broadcast as part of System Information (e.g., WTRU may select the PLMN ID to join the CPN); the list of cells to be added, existing cells to be modified, or cells to be deleted; cells to be activated or deactivated; and/or, user plane function between PRAS and eRG (e.g., Flow control, fast retransmission of PDCP PDUs lost due to radio link outage, discarding redundant PDUs, the retransmitted data indication, and the status report).

At 1306, the eRG may receive a capability information inquiry. At 1307, the capability information may be sent to the 5G-AN. The eRG may inform 5GC about its capability to support CPN call forwarding and routing, and available services, such as: direct connectivity through local UPF; support transition from D2D to connectivity through eRG and vice versa; relay/pass-through for Public network; and/or available supported services. See Table 3, which shows an example of capability information. The template for an eRG may use a similar template as a WTRU template, as shown in Table 3, but it would be an eRG network capability IEI.

TABLE 3
is an example of eRG network capability

| 8 | 7 | 6 | 5 | 4 | 3 | 2 | 1 | |
|---|---|---|---|---|---|---|---|---|
| WTRU network capability IEI | | | | | | | | octet 1 |
| Length of WTRU network capability contents | | | | | | | | octet 2 |
| EEA0 | 128-EEA1 | 128-EEA2 | 128-EEA3 | EEA4 | EEA5 | EEA6 | EEA7 | octet 3 |
| EIA0 | 128-EIA1 | 128-EIA2 | 128-EIA3 | EIA4 | EIA5 | EIA6 | EIA7 | octet 4 |
| WTRUA0 | WTRUA1 | WTRUA2 | WTRUA3 | WTRUA4 | WTRUA5 | WTRUA6 | WTRUA7 | octet 5* |
| UCS2 | UIA1 | UIA2 | UIA3 | UIA4 | UIA5 | UIA6 | UIA7 | octet 6* |
| ProSe-dd | ProSe | H.245-ASH | ACC_CSFB | LPP | LCS | 1xSRVCC | NF | octet 7* |
| ePCO | HC-CP | ERw/o | S1-U | UP CIoT | CP CIoT | ProSe- | ProSe-dc | octet 8* |
| | CIoT | PDN | data | | | relay | | |
| 15 bearers | SGC | N1mode | DCNR | CP | RestrictEC | V2XPC5 | multipleDRB | octet 9* |
| | | | | backoff | | | | |
| CPN - | D2D to | Pass | Supported | 0 | 0 | 0 | 0 | octet 10* |
| Intra direct | intra | through | Services | | | | | |
| connectivity, | connectivity | for | | | | | | |
| Local access | | public | | | | | | |
| | | network | | | | | | |
| 0 | 0 | 0 | 0 | 0 | 0 | 0 | 0 | octet 11*-15* |

Spare

At 1308, the 5G-AN may send the capability information to the 5GC/AMF. The 5GC/AMF may use the capability information to: Direct Connectivity through Local UPF, where AMF is aware of local UPF and maintains an association with remote SMF, selects the local UPF to enforce any policy/QoS for WTRU connected to CPN; support transition from D2D to connectivity through eRG and vice versa, where 5GC may instruct eRG to transition a user session from D2D to “intra-routing” in eRG based on reported measurements and available QOS; pass through/relay support for public network, where AMF maintains an association with other AMF for WTRU, and aware of the relay for CONTROL PLANE and USER PLANE; and/or, available services that may match with subscription database for users to allow such service and allocate user plane resources, and/or may advertise the availability of services through service enablement layer (SA6).

At 1309, the eRG and 5G-AN may perform security mode and/or RRC reconfiguration. In some examples, this may be performed based on previous steps of the process.

At 1310, the 5G-AN may send an NGAP initial context setup response to the 5GC/AMF. At 1311, the 5G-AN may send a message regarding the NGAP registration being completed (e.g., see FIG. 11 box 1102 where context is setup for 5G-AN protocol and NGAP layer).

The Service Request procedures for eRG in CM-IDLE state may be performed, and if the eRG is authorized to use CPN services, then the AMF may include “CPN authorized” information in the NGAP message, indicating which of the CPN services the eRG is authorized to use. These authorized CPN services may be used or not by the eRG for visiting WTRUs, depending on the Authorized Administrator preferences. Also, the AMF may send the “Remote WTRU” QoS parameters to NG-RAN via N2 signaling.

For handling of the user plane in eRG (-WTRU and CPN), the setting up and handling of user plane may be divided into two parts: Registration Procedure; and PDU Establishment.

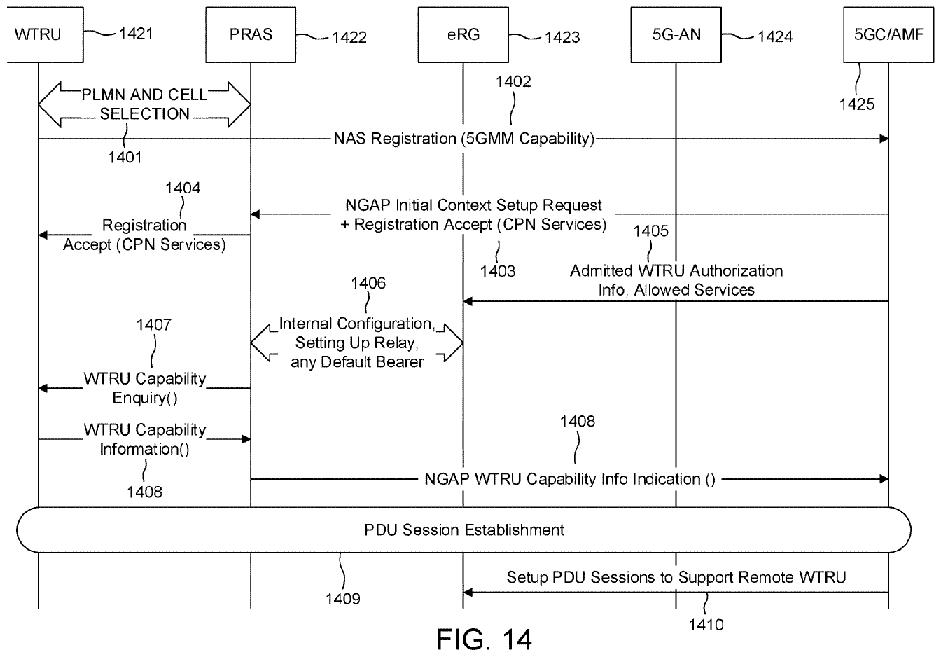

FIG. 14 illustrates an example of a WTRU registration process involving an eRG. For this example, there may be a WTRU (e.g., 5G) 1421, a PRAS 1422, an eRG 1423, a 5G-AN 1424, and a 5GC/AMF 1425. As shown, at 1401, there may be PLMN and cell selection, where a WTRU may select the CPN_PLMN_ID and cell based on a Closed Access Group (CAG) ID. The CPN_PLMN_ID may identify the CPN network uniquely from the 5GC. The base station (e.g., eNB/gNB) may select the AMF based on the WTRU's 5G-S-TMSI. The selected AMF (e.g., for the WTRU) may need to determine the AMF serving the eRG. There may be more than one technique for determining the serving eRG.

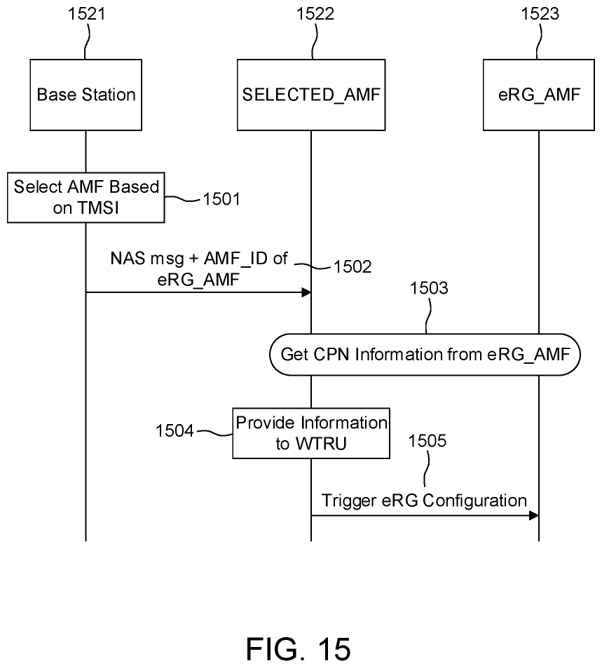

FIG. 15 illustrates an example of an aspect of a WTRU registration process, such as part of the eRG configuration/determination. For this example scenario, there may be a base station (e.g., eNB/gNB) 1521, a selected AMF 1522, and a eRG_AMF 1523 (e.g., the AMF serving the eRG). Generally, the base station may identify its own serving AMF first and send WTRU s NAS message along with the AMF ID of the AMF that serves the eRG. As shown, at 1501, the base station may select the AMF based on WTRU's 5G-S-TMSI, and at 1502 the base station may provide the AMF ID (of the AMF serving the eRG) with WTRU's NAS to the selected AMF (e.g., serving the WTRU). At 1503, the selected AMF (serving the WTRU) retrieves CPN's information from the AMF (serving the eRG) based on the received AMF ID. At 1504, the selected AMF may provide the information to the WTRU, and at 1505 the eRG configuration may be triggered. In one instance, the trigger is based on the WTRU information, capability, service requested by the WTRU, and/or policy. This information triggers the need to configure eRG so that it can support the requested service. Hence the configuration request is sent to the AMF, which is serving the eRG. The AMF, serving the eRG, may send a configuration message to the eRG to set up control information, policy, and/or user plane.

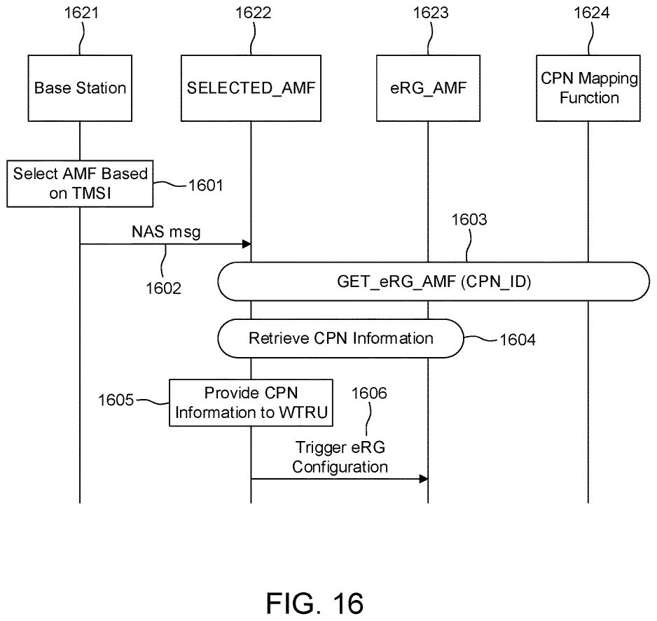

FIG. 16 illustrates an example of an aspect of a WTRU registration process, such as part of the eRG configuration/determination. For this example scenario, there may be a base station 1621, a selected AMF 1622, an eRG_AMF 1623, and a CPN mapping function 1624. As shown, at 1601, the base station may select an AMF (e.g., selected_AMF) based on WTRU's 5G-S-TMSI. AT 1602, there may be a NAS message from the base station to the selected AMF (e.g., related to the selection of the AMF). At 1603, the interaction between the selected AMF and the “CPN mapping function” may determine the eRG_AMF. At 1604, the selected AMF (serving WTRU) retrieves CPN's information from AMF (serving eRG). At 1605, the selected AMF may provide CPN information to the WTRU. At 1606, the selected AMF may trigger eRG configuration (e.g., the AMF serving the eRG may configure the eRG).

Referring back to FIG. 14, at 1402, the WTRU may send NAS Registration with its CPN_PLMN_ID as part of the updated “5GMM capability” in the Registration Request message. In some instances, the Registration Request message may be forwarded to the AMF. The “5G CPN User” capability may indicate: Multi RAT, such as Dual connectivity to CPN (5GNR and WiFi); and/or, CPN Guest mode capability. See Table 4 for an example of the details in a 5GMM information element, including the capability information discussed herein.

TABLE 4
is an example of details of 5GMM capability IE

| 8 | 7 | 6 | 5 | 4 | 3 | 2 | 1 | |
|---|---|---|---|---|---|---|---|---|
| 5GMM capability IEI | | | | | | | | octet 1 |
| Length of 5GMM capability contents | | | | | | | | octet 2 |
| SGC | 5G-IPHC- | N3 data | 5G-CP | RestrictEC | LPP | HO attach | S1 mode | octet 3 |
| | CP CIoT | | CIoT | | | | | |
| RACS | NSSAA | 5G-LCS | V2XCNPC5 | V2XCEPC5 | V2X | 5G-UP | 5GSRVCC | octet 4* |
| | | | | | | CIoT | | |
| ProSe- | ProSe-dc | ProSe-dd | ER-NSSAI | 5G-EHC- | multipleUP | WUSA | CAG | octet 5* |
| l2relay | | | | CP CIoT | | | | |
| 0 | 0 | 0 | 0 | CPN User | ProSe-l3rmt | ProSe-l2rmt | ProSe-l3relay | octet 6* |
| Spare | | | | with Multi | | | | |
| | | | | RAT & | | | | |
| | | | | Guest | | | | |
| | | | | Access | | | | |
| 0 | 0 | 0 | 0 | 0 | 0 | 0 | 0 | octet 7*-15* |

Spare

The purpose of the 5GMM capability information element may be to provide the network with information concerning aspects of the WTRU related to the 5GCN or interworking with the EPS. The contents might affect the manner in which the network handles the operation of the WTRU.

The “CPN Multi RAT & Guest Access” bit may indicate: the capability for WTRU to connect to PRAS/eRG via 5GNR or WiFi, where the 5G system uses this capability of WTRU for seamless and flawless user experience irrespective of whether the RAT the user is camping in, or user mobility between RATs; and/or, the capability for WTRU to operate in guest mode. The 5G system may use this capability of WTRU to prevent or allow a (guest) WTRU to discover and/or use the services provided by the eRG on the CPN.

The AMF may receive one or more NAS messages from the WTRU via N1-WTRU interface and associate the WTRU's context with the eRG's context based on the eRG's ID or CPN_PLMN_ID. The AMF may store the “5G CPN User” Capability for 5G CPN operation. The AMF may obtain the “5G CPN User” subscription data as part of the user subscription data from UDM during the eRG Registration procedure using Nudm_SDM service.

The AMF may determine whether the WTRU is authorized to use the 5G CPN services based on the WTRU's CPN Capability and the “CPN Service Authorization” included in the subscription data received from UDM. The AMF may store the authorized “5G CPN User” Capability.

The AMF may send the authorized “5G CPN User” Capability for 5G CPN operation to a PCF. Based on the received 5G CPN User Capability from the AMF, the PCF may provide QoS parameters to AMF for: a remote WTRU; and/or, service specific QoS. The AMF may store such information as part of the WTRU context.

At 1403, the AMF may initiate a session setup with the PRAS (e.g., relayed from NG-RAN and eRG). The message may comprise the Registration Accept NAS message and one or more other elements. The message may carry one or more PDU session setup requests, where each PDU session is addressed with the “PDU Session ID”. The message may also carry the uplink TEID for every PDU session. Additionally, the AMF may provide CPN local service information to the WTRU, such as local DNN. Additionally/alternatively the AMF may send an NGAP message that may include an “Initial Context Setup Request” and “Registration Accept” sent to the PRAS (e.g., relayed from NG-RAN and eRG), if WTRU is authorized to use “5G CPN User authorized” information, including one or more of the following: QoS details as part of WTRU context; and/or, whether the WTRU is authorized to connect to PRAS/eRG via Multi RAT.

The purpose of the “Initial Context Setup” procedure may be to establish the necessary overall initial WTRU Context at the PRAS/eRG, when required, including: PDU session context from eRG (e.g., PDU session to 5GC); Security Key; Mobility Restriction List; WTRU Radio Capability; and/or, WTRU Security Capabilities.

At 1404, the PRAS may send a Registration Accept message to WTRU, which may include WTRU configuration, such as radio parameters used in CPN. To demonstrate this, Table 5 shows an example of details of a Registration Accept message.

Table 5 is an example of details of a Registration Accept message with IE

| IEI | Information Element | Type/Reference | Presence | Format | Length |
|---|---|---|---|---|---|
| | Extended protocol | Extended protocol discriminator | M | V | 1 |
| | discriminator | 9.2 | | | |
| | Security header type | Security header type | M | V | ½ |
| | | 9.3 | | | |
| | Spare half octet | Spare half octet | M | V | ½ |
| | | 9.5 | | | |
| | Registration accept message | Message type | M | V | 1 |
| | identity | 9.7 | | | |
| | 5GS registration result | 5GS registration result | M | LV | 2 |
| | | 9.11.3.6 | | | |
| 77 | 5G-GUTI | 5GS mobile identity | O | TLV-E | 14 |
| | | 9.11.3.4 | | | |
| | CPN_User_Info | 5GS CPN User info | | | |
| | Struct | | | | |
| | { | | | | |
| | Local DN name, info, | | | | |
| | Available CPN services, | | | | |
| | expected QOS, security info | | | | |
| | } | | | | |
| 4A | Equivalent PLMNs | PLMN list | O | TLV | 5-47 |
| | | 9.11.3.45 | | | |
| 54 | TAI list | 5GS tracking area identity list | O | TLV | 9-114 |
| | | 9.11.3.9 | | | |
| 15 | Allowed NSSAI | NSSAI | O | TLV | 4-74 |
| | | 9.11.3.37 | | | |
| 11 | Rejected NSSAI | Rejected NSSAI | O | TLV | 4-42 |
| | | 9.11.3.46 | | | |
| 31 | Configured NSSAI | NSSAI | O | TLV | 4-146 |
| | | 9.11.3.37 | | | |
| 21 | 5GS network feature support | 5GS network feature support | O | TLV | 3-5 |
| | | 9.11.3.5 | | | |
| 50 | PDU session status | PDU session status | O | TLV | 4-34 |
| | | 9.11.3.44 | | | |
| 26 | PDU session reactivation result | PDU session reactivation result | O | TLV | 4-34 |
| | | 9.11.3.42 | | | |
| 72 | PDU session reactivation result | PDU session reactivation result | O | TLV-E | 5-515 |
| | error cause | error cause | | | |
| | | 9.11.3.43 | | | |
| 79 | LADN information | LADN information | O | TLV-E | 12-1715 |
| | | 9.11.3.30 | | | |
| B- | MICO indication | MICO indication | O | TV | 1 |
| | | 9.11.3.31 | | | |
| 9- | Network slicing indication | Network slicing indication | O | TV | 1 |
| | | 9.11.3.36 | | | |
| 27 | Service area list | Service area list | O | TLV | 6-114 |
| | | 9.11.3.49 | | | |
| 5E | T3512 value | GPRS timer 3 | O | TLV | 3 |
| | | 9.11.2.5 | | | |
| 5D | Non-3GPP de-registration | GPRS timer 2 | O | TLV | 3 |
| | timer value | 9.11.2.4 | | | |
| 16 | T3502 value | GPRS timer 2 | O | TLV | 3 |
| | | 9.11.2.4 | | | |
| 34 | Emergency number list | Emergency number list | O | TLV | 5-50 |
| | | 9.11.3.23 | | | |
| 7A | Extended emergency number | Extended emergency number list | O | TLV-E | 7-65538 |
| | list | 9.11.3.26 | | | |
| 73 | SOR transparent container | SOR transparent container | O | TLV-E | 20-n |
| | | 9.11.3.51 | | | |
| 78 | EAP message | EAP message | O | TLV-E | 7-1503 |
| | | 9.11.2.2 | | | |
| A- | NSSAI inclusion mode | NSSAI inclusion mode | O | TV | 1 |
| | | 9.11.3.37A | | | |
| 76 | Operator-defined access | Operator-defined access | O | TLV-E | 3-8323 |
| | category definitions | category definitions | | | |
| | | 9.11.3.38 | | | |
| 51 | Negotiated DRX parameters | 5GS DRX parameters | O | TLV | 3 |
| | | 9.11.3.2A | | | |
| D- | Non-3GPP NW policies | Non-3GPP NW provided policies | O | TV | 1 |
| | | 9.11.3.36A | | | |
| 60 | EPS bearer context status | EPS bearer context status | O | TLV | 4 |
| | | 9.11.3.23A | | | |
| 6E | Negotiated extended DRX | Extended DRX parameters | O | TLV | 3 |
| | parameters | 9.11.3.26A | | | |
| 6C | T3447 value | GPRS timer 3 | O | TLV | 3 |
| | | 9.11.2.5 | | | |
| 6B | T3448 value | GPRS timer 2 | O | TLV | 3 |
| | | 9.11.2.4 | | | |
| 6A | T3324 value | GPRS timer 3 | O | TLV | 3 |
| | | 9.11.2.5 | | | |
| 67 | WTRU radio capability ID | WTRU radio capability ID | O | TLV | 3-n |
| | | 9.11.3.68 | | | |
| E- | WTRU radio capability ID | WTRU radio capability ID deletion | O | TV | 1 |
| | deletion indication | indication | | | |
| | | 9.11.3.69 | | | |
| 39 | Pending NSSAI | NSSAI | O | TLV | 4-146 |
| | | 9.11.3.37 | | | |
| 74 | Ciphering key data | Ciphering key data | O | TLV-E | 34-n |
| | | 9.11.3.18C | | | |
| 75 | CAG information list | CAG information list | O | TLV-E | 3-n |
| | | 9.11.3.18A | | | |
| 1B | Truncated 5G-S-TMSI | Truncated 5G-S-TMSI | O | TLV | 3 |
| | configuration | configuration | | | |
| | | 9.11.3.70 | | | |
| 1C | Negotiated WUS assistance | WUS assistance information | O | TLV | 3-n |
| | information | 9.11.3.71 | | | |
| 29 | Negotiated NB-N1 mode DRX | NB-N1 mode DRX parameters | O | TLV | 3 |
| | parameters | 9.11.3.73 | | | |
| 68 | Extended rejected NSSAI | Extended rejected NSSAI | O | TLV | 5-90 |
| | | 9.11.3.75 | | | |
| 7C | Service-level-AA container | Service-level-AA container | O | TLV-E | 6-n |
| | | 9.11.2.10 | | | |

The WTRU may use the received “CPN_User_Info” to configure itself.

The following WTRU configurations may be performed: UPF configurations between WTRU and PRAS/eRG, which may include flow control, fast retransmission of PDCP PDUs lost due to radio link outage, discarding redundant PDUs, the retransmitted data indication, and the status report; the Local DN name is set in the WTRU, where the WTRU may select the Local DN name to join the CPN; the list of available CPN services such as a 5G LAN, direct communication, direct discovery, and the like may be used by the WTRU; and/or, the WTRU may request specific QoS for specific service data flows.

At 1405, the AMF may send the WTRU's authorization information to the eRG via NAS signaling (e.g., Ni-eRG interface), such as UCU with CPN configuration IE. This CPN configuration may be used to configure the PRAS using the F1 interface between the PRAS and the eRG in a manner similar to a central unit and a distributed unit architecture (e.g., as described herein with respect to gNB-DU and gNB-CU in NG-RAN architecture). For instance, at 1406, there may be internal configuration, setting up a relay, and/or addressing any default bearer; the internal configuration may be performed between the eRG and the PRAS. The maximum number of PRAS connected to an eRG may only be limited by a given implementation. The F1 interface may support signaling exchange and data transmission between the endpoints, separate protocol layers depending on the split choice used, and may enable the exchange of WTRU-associated and non-WTRU-associated signaling.

For example, one or more internal configurations may include F1 Interface Management Functions. These may comprise of F1 setup, eRG Configuration Update, PRAS Configuration Update, error indication, and/or reset function.

For example, one or more internal configurations may include System Information Management Functions. For instance, the PRAS may be responsible for the scheduling and broadcasting of system information. For system information broadcasting, the encoding of NR-MIB and SIB1 may be performed by the PRAS, while the encoding of other SI messages may be performed by the eRG. The F1 interface also provides signaling support for on-demand SI delivery, enabling WTRU energy saving.

For example, one or more internal configurations may include F1 WTRU Context Management Functions, where these functions may be responsible for the establishment and modification of the necessary WTRU context. The establishment of the F1 WTRU context may be initiated by the eRG, and the PRAS may accept or reject the establishment based on admission control criteria. In addition, an F1 WTRU context modification request may be initiated by either eRG or PRAS. The receiving node (e.g., eRG or PRAS) may accept or reject the modification. The F1 WTRU context management function may also be used to establish, modify and release Data Radio Bearers (DRBs) and Signaling Radio Bearers (SRBs).

For example, one or more internal configurations may include an RRC Message Transfer Function, where this function may be responsible for the transferring of RRC messages from the eRG to the PRAS and vice versa.

At 1407 and 1408, the WTRU may perform a capability information exchange (e.g., the WTRU receives an inquiry, and it responds with its capability information).

At 1408, the WTRU, in response to a user capability inquiry received from/via the PRAS, may inform the 5GC (e.g., through the PRAS) about its capability to support features, such as: Multi-RAT; ProSE; and/or, other available/supported services. Table 6 shows an example of WTRU network capability.

TABLE 6
is an example where WTRU network capability may be included in WTRU network capability information element

| 8 | 7 | 6 | 5 | 4 | 3 | 2 | 1 | |
|---|---|---|---|---|---|---|---|---|
| WTRU network capability IEI | | | | | | | | octet 1 |
| Length of WTRU network capability contents | | | | | | | | octet 2 |
| EEA0 | 128-EEA1 | 128-EEA2 | 128-EEA3 | EEA4 | EEA5 | EEA6 | EEA7 | octet 3 |
| EIA0 | 128-EIA1 | 128-EIA2 | 128-EIA3 | EIA4 | EIA5 | EIA6 | EIA7 | octet 4 |
| UEA0 | UEA1 | UEA2 | UEA3 | UEA4 | UEA5 | UEA6 | UEA7 | octet 5* |
| UCS2 | UIA1 | UIA2 | UIA3 | UIA4 | UIA5 | UIA6 | UIA7 | octet 6* |
| ProSe-dd | ProSe | H.245-ASH | ACC_CSFB | LPP | LCS | 1xSRVCC | NF | octet 7* |
| ePCO | HC-CP | ERw/o | S1-U | UP CIoT | CP CIoT | ProSe- | ProSe-dc | octet 8* |
| | CIoT | PDN | data | | | relay | | |
| 15 bearers | SGC | N1mode | DCNR | CP | RestrictEC | V2XPC5 | multipleDRB | octet 9* |
| | | | | backoff | | | | |
| CPN - | 0 | 0 | 0 | 0 | 0 | 0 | 0 | octet 10* |
| Multi-RAT, | | | | | | | | |
| ProSE | | | | | | | | |
| 0 | 0 | 0 | 0 | 0 | 0 | 0 | 0 | octet 11*-15* |

Spare

5GC/AMF may use the capability information to: Multi-RAT & ProSE, where AMF is aware of multi-RAT and ProSE capabilities of WTRU, and/or the 5GC/AMF provisions the eRG with an indication about the WTRU authorization status about 5G ProSe Direct Discovery/ProSe Direct Communication or multi-RAT communication; and/or, 5GC may also instruct Erg based on measurements and available QoS to setup PDU session distributed over multiple RATs, and/or transition the WTRU s connectivity from D2D to internally routed through eRG.

At 1409, PDU sessions may be established between the WTRU and 5GC. In one instance, this may be different from the PDU session establishment procedure for connecting two WTRUs with a local network or CPN.

At 1410, after the PDU session between the WTRU and 5GC has been set up, the 5GC may take one or more of the following actions: based on the CPN information to which the WTRU is connected, identify the eRG and associated AMF; AMF instructs eRG, over N1 interface, to modify and activate the existing PDU sessions between eRG and 5GC, so that the WTRUs PDU sessions may be supported; and/or, AMF may send over N1 interface to eRG, such as 5GC WTRU identity and associated PDU session (e.g., PDU sessions details), existing PDU sessions between eRG and 5GC, and/or authorized QoS, etc.

For PDU session establishment for local breakout in the CPN, after a WTRU is registered and connected to the CPN, as described herein, the WTRU may establish PDU sessions to access devices and services in the CPN via the eRG. When the WTRU establishes a PDU session to a DN, a default non-GBR (non-Guaranteed Bit Rate) QoS Flow without any Packet Filter may also be set up to carry the WTRU's traffic to the DN and vice versa. Both the WTRU (e.g., WTRU-Initiated) and the network (e.g., Network-Initiated) may create additional QoS Flows with different QoS characteristics from the default QoS Flow using the WTRU-Initiated or the Network-Initiated PDU Session Modification Request to the SMF.

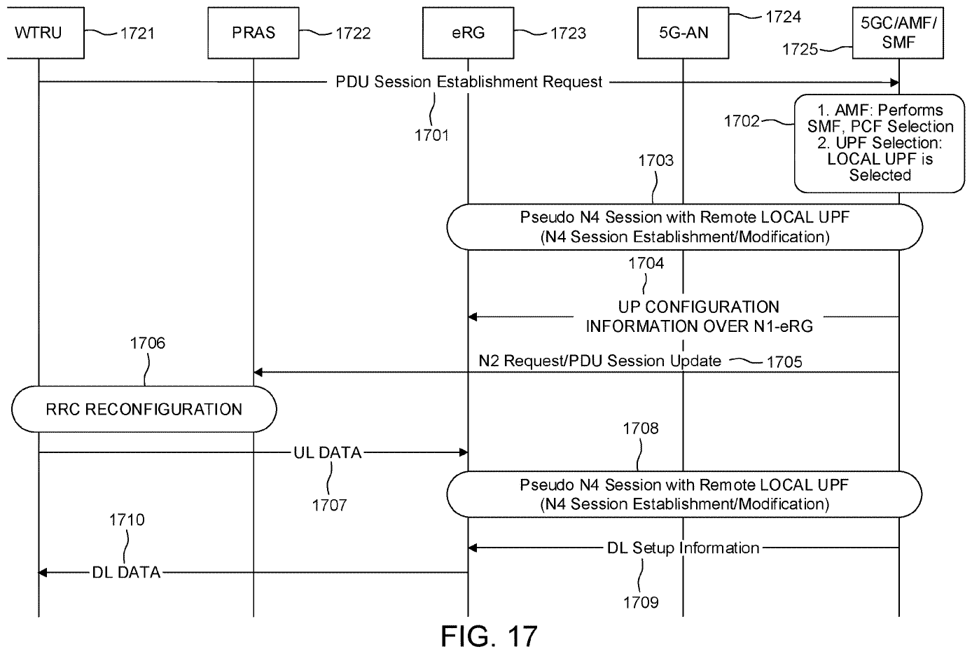

FIG. 17 illustrates an example of establishing a default PDU session within a CPN (e.g., towards a local DDN). In this example scenario, there may be a WTRU 1721, a PRAS 1722, an eRG 1723, a 5G-AN 1724, and a 5GC/AMF/SMF 1725.

At 1701, the WTRU may start a PDU session establishment procedure, including sending a request by providing the following Es to the PRAS/AMF, which may be included in the SMFs “nsm-pdusession_CreateSM-Context” message such as the: WTRUs SUPI (Subscriber Permanent Identifier); target DNN (Data Network Name), which is the Local DNN name which was provided to the WTRU while registering; service name or service Identifier, which is the service in Local DNN; authorization information to use the service; anType (Access Network Type), which is CPN_ID or CPN_NAME; and/or sNssai (Single Network Slice Service Assistance Identifier). Table 7 shows an example message of the PDU Establishment Request used by the WTRU.

Table 7 is an example message of the PDU Establishment Request used by the WTRU

| IEI | Information Element | Type/Reference | Presence | Format | Length |
|---|---|---|---|---|---|
| | Extended protocol | Extended protocol discriminator | M | V | 1 |
| | discriminator | 9.2 | | | |
| | PDU session ID | PDU session identity | M | V | 1 |
| | | 9.4 | | | |
| | PTI | Procedure transaction identity | M | V | 1 |
| | | 9.6 | | | |
| | PDU SESSION | Message type | M | V | 1 |
| | ESTABLISHMENT | 9.7 | | | |
| | REQWTRUST message | | | | |
| | identity | | | | |
| | Integrity protection maximum | Integrity protection maximum data | M | V | 2 |
| | data rate | rate | | | |
| | | 9.11.4.7 | | | |
| 9- | PDU session type | PDU session type | O | TV | 1 |
| | | 9.11.4.11 | | | |
| A- | SSC mode | SSC mode | O | TV | 1 |
| | | 9.11.4.16 | | | |
| 28 | 5GSM capability { an_TYPE: | 5GSM capability | O | TLV | 3-15 |
| | CPN_NAME, CPN_ID} | 9.11.4.1 | | | |
| | Note: AN type may be included | | | | |
| | here | | | | |
| 55 | Maximum number of supported | Maximum number of supported | O | TV | 3 |
| | packet filters | packet filters | | | |
| | | 9.11.4.9 | | | |
| B- | Always-on PDU session | Always-on PDU session requested | O | TV | 1 |
| | requested | 9.11.4.4 | | | |
| 39 | SM PDU DN request container | SM PDU DN request container | O | TLV | 3-255 |
| | { | 9.11.4.15 | | | |
| | LOCAL DNN FOR CPN ; | | | | |
| | Service_name ; | | | | |
| | Service_Identifier ; | | | | |
| | Authorization_Info | | | | |
| | } | | | | |
| 7B | Extended protocol | Extended protocol configuration | O | TLV-E | 4-65538 |
| | configuration options | options | | | |
| | | 9.11.4.6 | | | |
| 66 | IP header compression | IP header compression | O | TLV | 5-257 |
| | configuration | configuration | | | |
| | | 9.11.4.24 | | | |
| 6E | DS-TT Ethernet port MAC | DS-TT Ethernet port MAC address | O | TLV | 8 |
| | address | 9.11.4.25 | | | |
| 6F | WTRU-DS-TT residence time | WTRU-DS-TT residence time | O | TLV | 10 |
| | | 9.11.4.26 | | | |
| 74 | Port management information | Port management information | O | TLV-E | 8-65538 |
| | container | container | | | |
| | | 9.11.4.27 | | | |
| 1F | Ethernet header compression | Ethernet header compression | O | TLV | 3 |
| | configuration | configuration | | | |
| | | 9.11.4.28 | | | |
| 29 | Suggested interface identifier | PDU address | O | TLV | 11 |
| | | 9.11.4.10 | | | |
| 7C | Service-level-AA container | Service-level-AA container | O | TLV-E | 6-n |
| | | 9.11.2.10 | | | |
| 23 | Requested MBS container | Requested MBS container | O | TLV | 7-n |
| | | 9.11.4.30 | | | |

At 1702, the AMF may perform SMF/PCF selection. Then, UPF selection may occur. Once selected, the SMF may obtain the WTRU subscription details from the UDM and PCF. Based on “target DNN” and “anTYPE”, it may determine that the local UPF in eRG needs to be programmed. The SMF may identify the correct AMF for eRG, and it may obtain UPF information in the eRG.

At 1703, the SMF may request that the AMF for the eRG program the local UPF. The SMF may formulate an equivalent of PFCP (Packet Forward Control Packet) Session Establishment request to program the local UPF to create a Session Management (SM) context (e.g., PDU Session) for the WTRU. In one instance, there may be a pseudo N4 session with remote local UPF between the eRG, 5G-AN, and the 5GC/AMF/SMF (e.g., N4 session establishment/modification).

At 1704, the SMF indirectly (e.g., via the AMF of an eRG and N1 interface to the eRG) may send configuration information. In one case, the information may regard QoS constructs for the PDU Session and the default QoS Flow Establishment, triggering eRG configuration. The eRG configuration may include: SDF Template for UPF in eRG; DL and UL traffic classification (e.g., switching parameters); and/or, QoS Rule(s) in eRG. In one instance, QoS rules may include: Queuing and Scheduling, which includes enforcing GBR and non-GBR WTRU traffic such as UL/DL bandwidth, latency, traffic priority, etc.; and/or, Marking/Remarking, where it Marks the mobile traffic (e.g., set the packet's DSCP) when the traffic leaves towards the local DN (e.g., UL traffic) and the PRAS (e.g., DL traffic) so that the priority and QoS of the traffic may be honored in the DN and the gNB). In one case, this user plane configuration information may be sent over N1 to the eRG. In one case, the configuration information may be related to a PDU session of the WTRU.

The eRG may set one or more of the following: N3 GTP-U tunnel towards LOCAL UPF, which sets up the IP address for N3 GTP-U tunnel towards LOCAL UPF and provides the information to PRAS; QFI to some value, which enables identifying the default QoS Flow from the WTRU to the DN; UL and DL WTRU-AMBRs (Aggregated Maximum Bit Rate) in PRAS, where PRAS will drop any non-GBR AMBR traffic for the WTRU that are above those limits for UL and DL; and/or, gTP-TEID or TEID_cn (Tunnel Endpoint ID Core Node) for the WTRU in the PRAS, which is information that may be used for the PRAS to forward WTRU's UL traffic to the Local UPF for the DN.

The SMF may request LOCAL UPF to assign a IP address for the WTRU. It may obtain the assigned IP address and send it to the WTRU.

At 1705, the SMF may configure the PRAS and WTRU (e.g., via the AMF to PRAS, N1 message with the WTRU) by sending one or more messages, such with an N2 request and/or a PDU session update. For example, one message may include the following parameters: QoS constructs for the PDU Session and the default QoS Flow Establishment, such as QoS Profile to PRAS, QoS Rule to WTRU (e.g., Queuing and Scheduling, regarding enforcing GBR and non-GBR WTRU traffic such as UL/DL bandwidth, latency, traffic priority, etc.); and/or, UL Traffic classification in WTRU.

The SMF may advise the WTRU (eRG) over the N1 HTTP/2 interface to set up Packet Filters to classify UL traffic to the Local DN. This packet filter is related to CPN, Local DN services.

The WTRU (WTRU in CPN) may use the same QFI, which is used to identify the default QoS Flow of the PDU Session. These QFI may be set by the eRG, which forwards it to SMF, then sent to WTRU.

In some instances, the SMF may send configurations to the WTUR may send the configuration to the eRG, such as UL/DL Session AMBRs to WTRU (eRG). The WTRU may enforce its SDF UL traffic and drop any traffic over the limit.

The WTRU's (WTRU in CPN) IP address, such as obtained in step 4, may be sent by SMF to WTRU (WTRU in CPN).

Alternatively, QoS Profile for PRAS may be sent to eRG in step 4, and/or the eRG may configure PRAS.

At 1706, using an RRC configuration, the Radio Bearer (DRB) between the WTRU and the PRAS may be established. This DRB may be associated with the N3 GTP-U tunnel towards local UPF in the eRG, which was established earlier.

At 1707, the WTRU may now send a UL packet to the DN. In one instance, the WTRU has a default QoS Flow to match its UL traffic to the DRB (Data Radio Bearer) identified by the QFI to the PRAS; and/or, the PRAS may know the IP address of the UPF and the TEID_cn of the WTRU for forwarding UL traffic to the Local UPF and DN. Upon receipt of the packet, the eRG will (also) have to determine where the packet should be directed, in effect, acting as a switch, based on information from the WTRU and/or from prior configurations.

At 1708, eRG may first set up an N4 session between local UPF and SMF by sending an equivalent of PFCP (Packet Forward Control Packet) Session Establishment request to create a Session Management (SM) context (e.g., PDU Session) for the WTRU.

At 1709 downlink (DL) setup information may be sent from the 5GC/AMF/SMF to the eRG. The UPF may still not yet know the AN_Tunnel (e.g., PRAS IP address and WTRU's TEID_an) on the PRAS. The SMF may use the PRAS's provided AN_Tunnel info to update the AN_Tunnel info for the SM Context on the Local UPF so that the UPF may start sending DL traffic to the WTRU via the PRAS; and/or, the AMF may invoke the SMF's Nsmf-PDU_Session_UpdateSMContext service call, so that the SMF may update the SM context on the UPF for the AN_Tunnel for the eRG, where the SMF may send this information to eRG, by identifying the AMF for eRG over N1 interface. In one instance, there may be a pseudo N4 session with remote local UPF (e.g., an NF session establishment/modification procedure).

At 1710, the DL data may be directed from the eRG to the WTRU based on one or more aspects of a prior configuration.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves, irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented by an enhanced residential gateway (eRG), the method comprising:
receiving configuration information, via an N1 interface, from a session management function (SMF), wherein the configuration information includes switching information that determines whether one or more packets from a first wireless transmit receive unit (WTRU) go to a Customer Premise Network (CPN) or a core network, wherein the eRG is operatively connected to the CPN, the core network, and the first WTRU;
receiving a packet from the first WTRU, wherein the packet is related to a PDU session established by the first WTRU; and
sending the packet to the CPN or the core network based on the configuration information.

2. The method of claim 1, wherein the configuration information relates to the PDU session that is established by the first WTRU.

3. The method of claim 1, wherein the configuration information further includes packet forwarding information for the first WTRU in the CPN for forwarding the packet to a second WTRU in the CPN.

4. The method of claim 1, wherein the configuration information further includes QoS parameters related to the PDU session.

5. The method of claim 1, wherein the configuration information further includes QoS information including a guaranteed bit rate (GBR) related to the PDU session.

6. The method of claim 1, wherein the configuration information further includes QoS information including a buffer size related to the PDU session.

7. An enhanced residential gateway (eRG), the eRG comprising:
a processor operatively coupled to a transceiver, the processor and transceiver configured to receive configuration information, via an N1 interface, from a session management function (SMF), wherein the configuration information includes switching information that determines whether one or more packets from a first wireless transmit receive unit (WTRU) go to a Customer Premise Network (CPN) or a core network, wherein the eRG is operatively connected to the CPN, the core network, and the first WTRU;
the processor and transceiver configured to receive a packet from the first WTRU, wherein the packet is related to a PDU session established by the first WTRU; and
the processor and transceiver configured to send the packet to the CPN or the core network based on the configuration information.

8. The eRG of claim 7, wherein the configuration information relates to the PDU session that is established by the first WTRU.

9. The eRG of claim 7, wherein the configuration information further includes packet forwarding information for the first WTRU in the CPN for forwarding the packet to a second WTRU in the CPN.

10. The eRG of claim 7, wherein the configuration information further includes QoS parameters related to the PDU session.

11. The eRG of claim 7, wherein the configuration information further includes QoS information including a guaranteed bit rate (GBR) related to the PDU session.

12. The eRG of claim 7, wherein the configuration information further includes QoS information including a buffer size related to the PDU session.
